(19) United States
(12) Patent Application Publication
(10) Pub. No.: US 2018/0183577 A1
(43) Pub. Date: Jun. 28, 2018

(54) TECHNIQUES FOR SECURE MESSAGE AUTHENTICATION WITH UNIFIED HARDWARE ACCELERATION

(71) Applicant: INTEL CORPORATION, SANTA CLARA, CA (US)

(72) Inventors: VIKRAM B. SURESH, PORTLAND, OR (US); KIRK S. YAP, WESTBOROUGH, MA (US); SANU K. MATHEW, HILLSBORO, OR (US); SUDHIR K. SATPATHY, HILLSBORO, OR (US)

(73) Assignee: INTEL CORPORATION, SANTA CLARA, CA (US)

(21) Appl. No.: 15/393,196

(22) Filed: Dec. 28, 2016

(51) Int. Cl. H04L 9/06; H04L 9/32

(52) U.S. Cl. CPC H04L 9/0643; H04L 9/3239

(57) ABSTRACT

Techniques and computing devices for secure message authentication and, more specifically, but not exclusively, to techniques for unified hardware acceleration of hashing functions, such as SHA-1 and SHA-256 are described. In one embodiment, for example, an apparatus for hardware accelerated hashing in a computer system mat include at least one memory and at least one processor. The apparatus may further include logic comprising at least one adding circuit shared between a first hash function and a second hash function, the logic to perform hardware accelerated hashing of an input message stored in the at least one memory. At least a portion of the logic may be comprised in hardware and executed by the processor to receive the input message to be hashed using the first hash function, perform message expansion of the input message per requirements of the first hash function, perform hashing of the expanded input message over at least four computation rounds, perform, in each of a first, second, and third computation round, more than a single round of computation for the first hash function, and generate a message digest for the input message based upon the first hash function. Other embodiments are described and claimed.

### TECHNICAL FIELD

Embodiments described herein generally relate to secure message authentication and, more specifically, but not exclusively, to techniques for unified hardware acceleration of hash functions, such as SHA-1 and SHA-256.

### BACKGROUND

The family of Secure Hash Algorithms (SHA) includes SHA-1, SHA-256, SHA-384, and SHA-512. These hash algorithms are standardized by the National Institute of Standards and Tests (NIST), published in FIPS 180-4. In part due to their standardization, SHA-1, SHA-256, SHA-384, and SHA-512 are widely used and, sometimes, required by certain parties, such as the government. Hash algorithms are typically used to transform an electronic message into a condensed representation of the electronic message, called a message digest. Each of these hash algorithms provides some level of security due to the difficulty of computing an original electronic message from a message digest, and the difficulty of producing the same message digest using two different electronic messages, called a collision. SHA-1 provides the lowest level of security in the SHA family, but may be the least resource-intensive. SHA-256 provides more robust security, but requires additional resources. SHA-384 and SHA-512 are both incrementally more secure and resource-intensive. Based upon a balance of security and resource requirements, SHA-1 and SHA-256 are often used.

Traditionally, the SHA family of hash algorithms has been implemented in software, which may result in higher latency and low energy efficiency in some implementations. Specific hardware configured to perform SHA-1 or SHA-256 may be used in some instances, however, hardware configured for hashing may still suffer from inefficiencies. Further, in some cases, separate hardware may be needed to perform each of SHA-1 and SHA-256 hashing functions. Thus, improved techniques for performing hash functions are desired.

### BRIEF DESCRIPTION OF THE DRAWINGS

FIG. 1 illustrates an embodiment of an operating environment.

FIG. 2 illustrates an embodiment of a hash function hardware architecture.

FIG. 3A illustrates an embodiment of a first stage of hash function circuitry.

FIG. 3B illustrates an embodiment of a second stage of hash function circuitry.

FIG. 3C illustrates an embodiment of a third stage of hash function circuitry.

FIG. 3D illustrates an embodiment of a fourth stage of hash function circuitry.

FIG. 4A illustrates an embodiment of a first stage of hash function circuitry.

FIG. 4B illustrates an embodiment of a second stage of hash function circuitry.

FIG. 4C illustrates an embodiment of a third stage of hash function circuitry.

FIG. 4D illustrates an embodiment of a fourth stage of hash function circuitry.

FIG. 5A illustrates an embodiment of first message expansion logic.

FIG. 5B illustrates an embodiment of second message expansion logic.

FIG. 5C illustrates an embodiment of third message expansion logic.

FIG. 5D illustrates an embodiment of fourth message expansion logic.

FIG. 5E illustrates an embodiment of fifth message expansion logic.

FIG. 6 illustrates an embodiment of message expansion hardware architecture.

FIG. 7 depicts an illustrative logic flow according to a first embodiment.

FIG. 8 depicts an illustrative logic flow according to a second embodiment.

FIG. 9 illustrates an example of a storage medium.

FIG. 10 illustrates an example computing platform.

### DETAILED DESCRIPTION

The SHA-1 and SHA-256 hash algorithms are widely used to determine the integrity of an electronic message since any change to the message will, with a very high probability, result in a different message digest. Likewise, it is highly unlikely that two messages will result in the same message digest, creating a collision. Each hash algorithm may include two stages: preprocessing (including message expansion) and hash computation. Preprocessing may involve padding a message, parsing the padded message into m-bit blocks, and setting initialization values to be used in the hash computation. The hash computation may generate a message schedule from the padded message and may utilize that schedule, along with predefined functions, constants, and word operations to iteratively generate a series of hash values. The final hash value generated by the hash computation is used to determine the message digest.

Cryptographic hash functions, such as SHA-1 and SHA-256, may be critical in many products to support secure message authentication and digital signatures. They may be used in applications ranging from performance-intensive datacenters to energy-limited Internet of Things (IoT) devices. Since SHA-1 and SHA-256 are commonly used hash functions and attested by NIST in the FIPS 180-4 standard, dedicated accelerators for SHA-1 and SHA-256 hashing operation may enable higher performance and lower energy hash implementations for secure authentication protocols. Unifying the datapaths for the SHA-1 and SHA-256 hash functions, as illustrated and described herein, may provide area and energy efficient implementations to support both SHA-1 and SHA-256 across a wide range of platforms.

Various embodiments may be generally directed toward systems and techniques for hardware accelerated hash functions in a computer system. The computer system may comprise at least one memory, at least one processor, and logic including at least one adding circuit shared between a first hash function and a second hash function. The logic may be configured to perform hardware accelerated hashing of an input message stored in the at least one memory. At least a portion of the logic may be comprised in hardware and executed by the processor to receive the input message to be hashed using the first hash function, which may be SHA-1 in some embodiments. The logic may further perform message expansion of the input message per requirements of the first hash function. The logic may perform hashing of the expanded input message over at least four computation rounds, and perform, in each of a first, second, and third computation round, more than a single round of computation for the first hash function. The logic may generate a message digest for the input message based upon the first hash function.

During message expansion, various embodiment may include message expansion logic configured to receive the input message and perform a first cycle of message expansion of the input message using at least two adding circuits shared with message expansion logic of the second hash function to generate an intermediary message expansion. In some embodiments, the second hash function may comprise SHA-256. The message expansion logic may send the intermediary message expansion through a shared message expansion pipeline perform a second cycle of message expansion of the intermediary message using at least two additional adding circuits shared with message expansion logic of the second hash function to generate an expanded message.

Various embodiments may include a pipeline stage after each computation round shared between the first hash function and the second hash function, which may be implemented in a manner which reduces cell area. In addition, to the shared pipeline stages, at least one adding circuit may also be shared between each of the four computation rounds. As discussed further below, in some embodiments, particularly using SHA-256, the computation of each round may be split across two pipeline stages in such a way that the intermediate value of new state E is stored in carry-save format to reduce the critical path. The intermediate value of a new state A may be computed by subtracting a state D and then added with the intermediate value of a new state E to complete the computation.

In various embodiments, including during computation rounds of SHA-1, the logic may be configured to precompute a portion of the following computation round in each of computation rounds one, two, and three. In this manner, more than a single computation round may be performed, which may reduce critical path and cell area. This may be achieved using a combination of adders shared between two hash functions, such as SHA-1 and SHA-256, along with a set of shared pipeline registers, as illustrated and discussed in more detail herein.

In the following description, numerous specific details such as processor and system configurations are set forth in order to provide a more thorough understanding of the described embodiments. However, the described embodiments may be practiced without such specific details. Additionally, some well-known structures, circuits, and the like have not been shown in detail, to avoid unnecessarily obscuring the described embodiments.

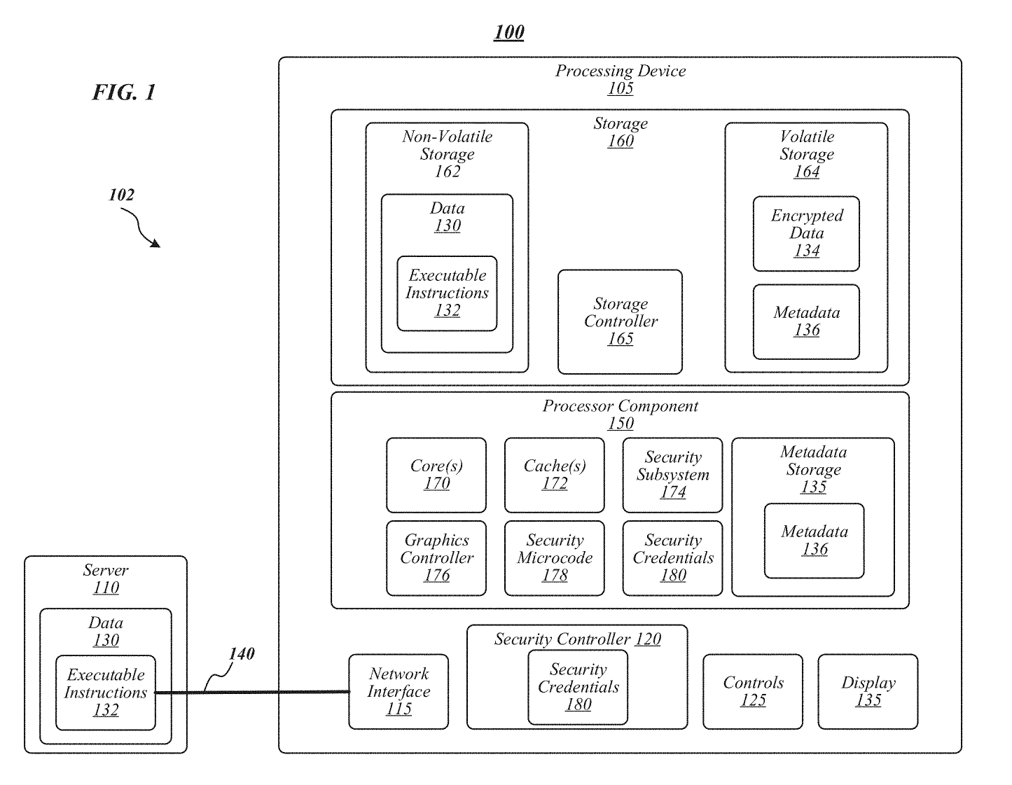

FIG. 1 illustrates an example of an operating environment 100 such as may be representative of some embodiments. In operating environment 100, which may include unified hardware acceleration of hash functions, a system 102 may include a server 110 and a processing device 105 coupled via a network 140. Server 110 and processing device 105 may exchange data 130 via network 140, and data 130 may include executable instructions 132 for execution within processing device 105. In some embodiments, data 130 may include data values, executable instructions, and/or a combination thereof. Network 140 may be based on any of a variety (or combination) of communications technologies by which signals may be exchanged, including without limitation, wired technologies employing electrically and/or optically conductive cabling, and wireless technologies employing infrared, radio frequency, and/or other forms of wireless transmission.

In various embodiments, processing device 105 may incorporate a processor component 150, a storage 160, controls 125 (for instance, manually-operable controls), a display 135 and/or a network interface 115 to couple processing device 105 to network 140. Processor component 150 may incorporate security credentials 180, a security microcode 178, metadata storage 135 storing metadata 136, a security subsystem 174, one or more processor cores 179, one or more caches 172 and/or a graphics controller 176. Storage 160 may include volatile storage 164, non-volatile storage 162, and/or one or more storage controllers 165. Processing device 105 may include a controller 120 (for example, a security controller) that may include security credentials 180. Controller 120 may also include one or more of the embodiments described herein for unified hardware acceleration of hash functions.

Volatile storage 164 may include one or more storage devices that are volatile inasmuch as they require the continuous provision of electric power to retain information stored therein. Operation of the storage device(s) of volatile storage 164 may be controlled by storage controller 165, which may receive commands from processor component 150 and/or other components of processing device 105 to store and/or retrieve information therein, and may convert those commands between the bus protocols and/or timings by which they are received and other bus protocols and/or timings by which the storage device(s) of volatile storage 164 are coupled to the storage controller 165. By way of example, the one or more storage devices of volatile storage 164 may be made up of dynamic random access memory (DRAM) devices coupled to storage controller 165 via an interface, for instance, in which row and column addresses, along with byte enable signals, are employed to select storage locations, while the commands received by storage controller 165 may be conveyed thereto along one or more pairs of digital serial transmission lines.

Non-volatile storage 162 may be made up of one or more storage devices that are non-volatile inasmuch as they are able to retain information stored therein without the continuous provision of electric power. Operation of storage device(s) of non-volatile storage 162 may be controlled by storage controller 165 (for example, a different storage controller than used to operate volatile storage 164), which may receive commands from processor component 150 and/or other components of processing device 105 to store and/or retrieve information therein, and may convert those commands between the bus protocols and/or timings by which they are received and other bus protocols and/or timings by which the storage device(s) of non-volatile storage 162 are coupled to storage controller 165. By way of example, one or more storage devices of non-volatile storage 162 may be made up of ferromagnetic disk-based drives (hard drives) operably coupled to storage controller 165 via a digital serial interface, for instance, in which portions of the storage space within each such storage device are addressed by reference to tracks and sectors. In contrast, commands received by storage controller 165 may be conveyed thereto along one or more pairs of digital serial transmission lines conveying read and write commands in which those same portions of the storage space within each such storage device are addressed in an entirely different manner.

Processor component 150 may include at least one processor core 170 to execute instructions of an executable routine in at least one thread of execution. However, processor component 150 may incorporate more than one of processor cores 170 and/or may employ other processing architecture techniques to support multiple threads of execution by which the instructions of more than one executable routine may be executed in parallel. Cache(s) 556 may include a multilayer set of caches that may include separate first level (L1) caches for each processor core 170 and/or a larger second level (L2) cache for multiple ones of processor cores 170.

In some embodiments in which processing device 105 includes display 135 and/or graphics controller 176, one or more cores 170 may, as a result of executing the executable instructions of one or more routines, operate controls 125 and/or the display 135 to provide a user interface and/or to perform other graphics-related functions. Graphics controller 176 may include a graphics processor core (for instance, a graphics processing unit (GPU)) and/or component (not shown) to perform graphics-related operations, including and not limited to, decompressing and presenting a motion video, rendering a 2D image of one or more objects of a three-dimensional (3D) model, etc.

Non-volatile storage 162 may store data 130, including executable instructions 132. In the aforementioned exchanges of data 130 between processing device 105 and server 110, processing device 105 may maintain a copy of data 130, for instance, for longer term storage within non-volatile storage 162. Volatile storage 164 may store encrypted data 134 and/or metadata 136. Encrypted data 134 may be made up of at least a portion of data 130 stored within volatile storage 164 in encrypted and/or compressed form according to some embodiments described herein. Executable instructions 132 may make up one or more executable routines such as an operating system (OS), device drivers and/or one or more application routines to be executed by one or more processor cores 170 of processor component 150. Other portions of data 130 may include data values that are employed by one or more processor cores 170 as inputs to performing various tasks that one or more processor cores 170 are caused to perform by execution of executable instructions 132.

As part of performing executable instructions 132, one or more processor cores 170 may retrieve portions of executable instructions 132 and store those portions within volatile storage 164 in a more readily executable form in which addresses are derived, indirect references are resolved and/or links are more fully defined among those portions in the process often referred to as loading. As familiar to those skilled in the art, such loading may occur under the control of a loading routine and/or a page management routine of an OS that may be among executable instructions 132. As portions of data 130 (including portions of executable instructions 132) are so exchanged between non-volatile storage 162 and volatile storage 164, security subsystem 174 may convert those portions of data 130 between what may be their original uncompressed and unencrypted form as stored within non-volatile storage 162, and a form that is at least encrypted and that may be stored within volatile storage 164 as encrypted data 134 accompanied by metadata 136.

Security subsystem 174 may include hardware logic configured or otherwise controlled by security microcode 178 to implement the logic to perform such conversions during normal operation of processing device 105. Security microcode 178 may include indications of connections to be made between logic circuits within the security subsystem 174 to form such logic. Alternatively or additionally, security microcode 178 may include executable instructions that form such logic when so executed. Either security subsystem 174 may execute such instructions of the security microcode 178, or security subsystem 174 may be controlled by at least one processor core 170 that executes such instructions. Security subsystem 174 and/or at least one processor core 170 may be provided with access to security microcode 178 during initialization of the processing device 105, including initialization of the processor component 150. Further, security subsystem 174 may include one or more of the embodiments described herein for unified hardware acceleration of hash functions.

Security credentials 180 may include one or more values employed by security subsystem 174 as inputs to its performance of encryption of data 130 and/or of decryption of encrypted data 134 as part of performing conversions therebetween during normal operation of processing device 105. More specifically, security credentials 180 may include any of a variety of types of security credentials, including and not limited to, hashes (e.g. using SHA-1 or SHA-256), public and/or private keys, seeds for generating random numbers, instructions to generate random numbers, certificates, signatures, ciphers, and/or the like. Security subsystem 174 may be provided with access to security credentials 180 during initialization of the processing device 105.

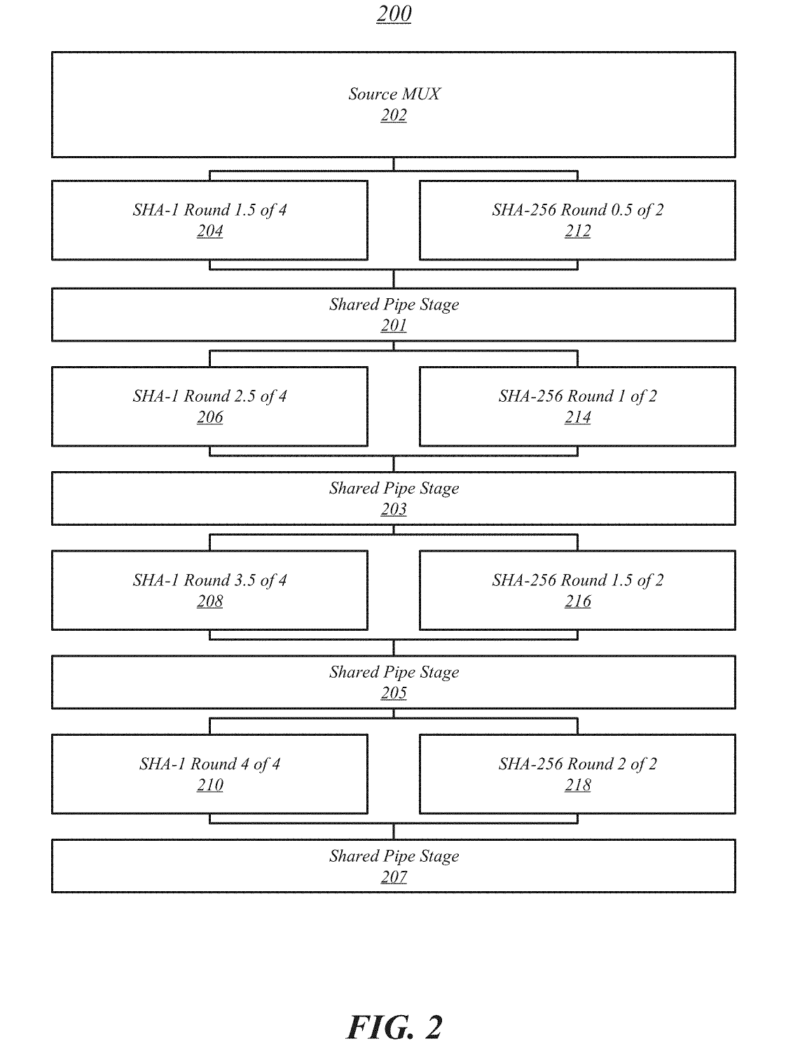

FIG. 2 illustrates an embodiment of a hash function hardware architecture 200. In an embodiment, the unified hardware acceleration may be configured for two hash functions, such as SHA-1 and SHA-256. While SHA-1 and SHA-256 are used as examples throughout this disclosure, it can be appreciated that the unified hardware acceleration techniques described herein may be used with other hash functions and other combinations of hash functions. For example, the use of shared adders, pre-computation within some computation rounds, and shared pipeline registers between multiple hashing functions may provide benefits to other hash functions within the SHA family, or others. Further, some embodiments may use the techniques described herein to add additional hash functions to the illustrated SHA-1 and SHA-256 architectures.

Two core operations in both SHA-1 and SHA-256 are the generation of a message digest to consume the input message, and message scheduler to expand the input message across all the SHA rounds. The hash function hardware architecture 200 illustrates a unified datapath for SHA-1 and SHA-256 message digest logic by sharing the area/power intensive adders, which may be 32-bit adders, and the intermediate pipeline stages. Hash function hardware architecture 200 illustrates two paths, which may be taken serially using either SHA-1 or SHA-256 hashing. As illustrated, SHA-1 may be split into four rounds (204, 206, 208, 210) and SHA-256 may be split into four rounds (212, 214, 216, 218). Between each round is a shared pipeline stage (201, 203, 205, 207) that may be utilized by each algorithm. While four rounds and four pipeline stages are illustrated in exemplary embodiments, it should be appreciated that more or less rounds and/or pipeline stages may be used in other embodiments while incorporating the techniques described herein. As illustrated and described further herein, within each round, adders may be shared between each algorithm to preserve area and power. In some embodiments, the adders may be 32-bit adders, however it can be appreciated that other types of adders may be used, particularly if the techniques described herein are used with other hash algorithms.

Traditionally SHA hash algorithms were implemented in software resulting in significant latency and low energy efficiency. The hardware accelerators used to support the SHA hashing algorithms required dedicated datapaths for each of the two hash functions. The shared datapaths for each of SHA-1 and SHA-256 illustrated within FIG. 2 may be optimized to pre-compute parts of subsequent computation rounds. This pre-computing allows more than one traditional round of computing to take place per round, in the case of SHA-1, and for strategic computation to be performed to increase the efficiency of later computation rounds, in the case of SHA-256. For example, with respect to the SHA-1 datapath illustrated on the left side of hash function hardware architecture 200, each round 204, 206, and 208 may precompute approximately half of the next round. As illustrated and described herein, with respect to SHA-256 on the right side of hash function hardware architecture 200, earlier rounds such as 212 may reformulate the computation of values, such as A_{new}, providing increased efficiency in later rounds. The described datapath optimizations and shared addition logic may improves the timing slack by up to 33% in some exemplary embodiments, resulting in significant area and power improvement. For example, cell area may be improved by 5-15% in some exemplary embodiments of round computation datapaths and message expansion datapaths.

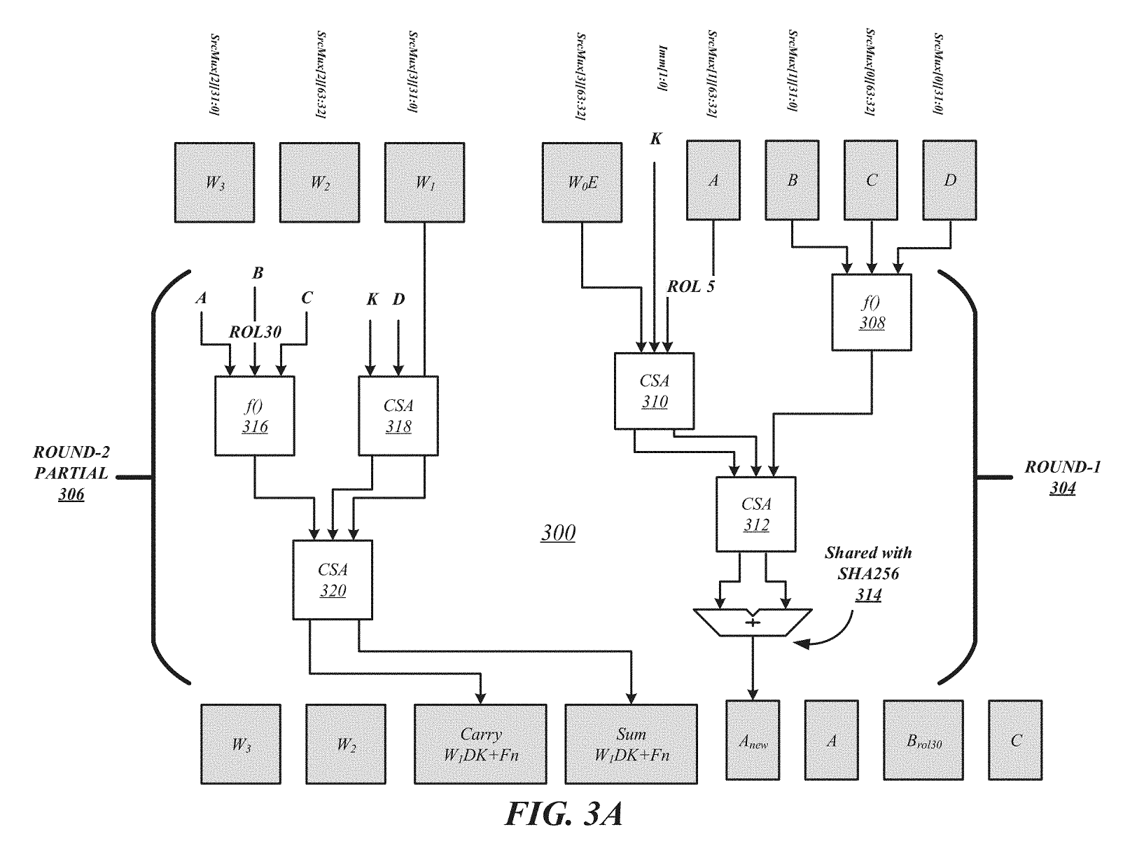

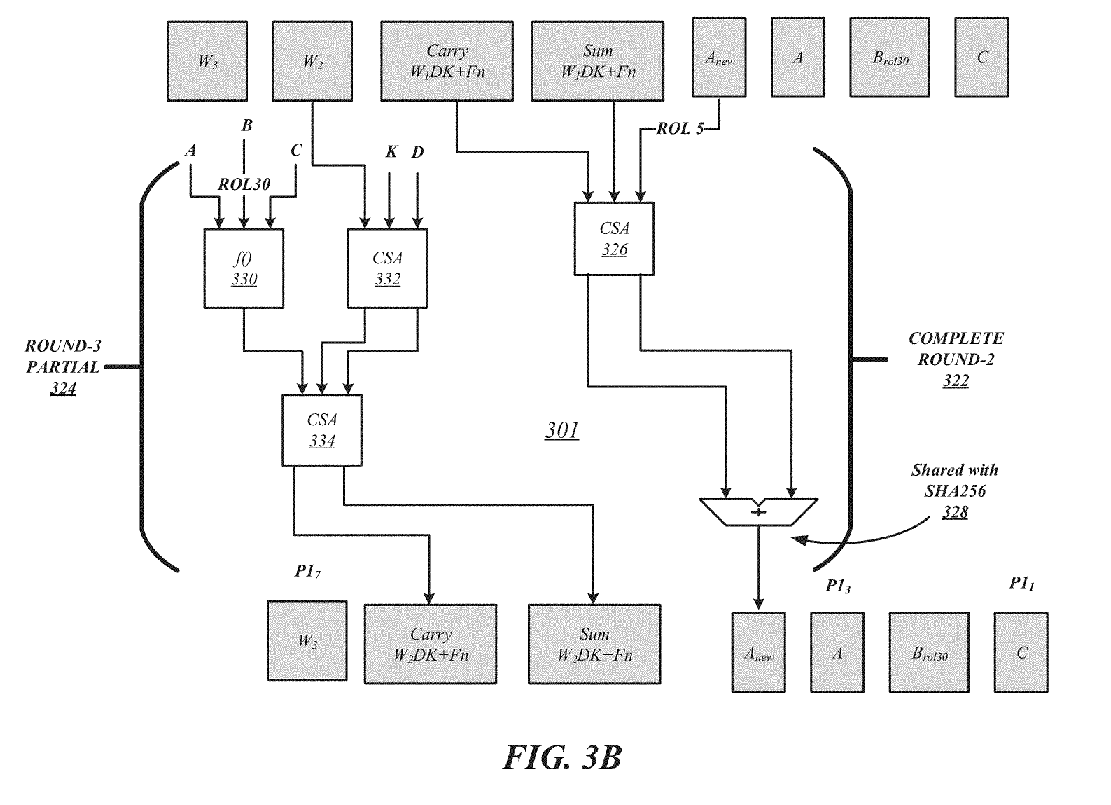

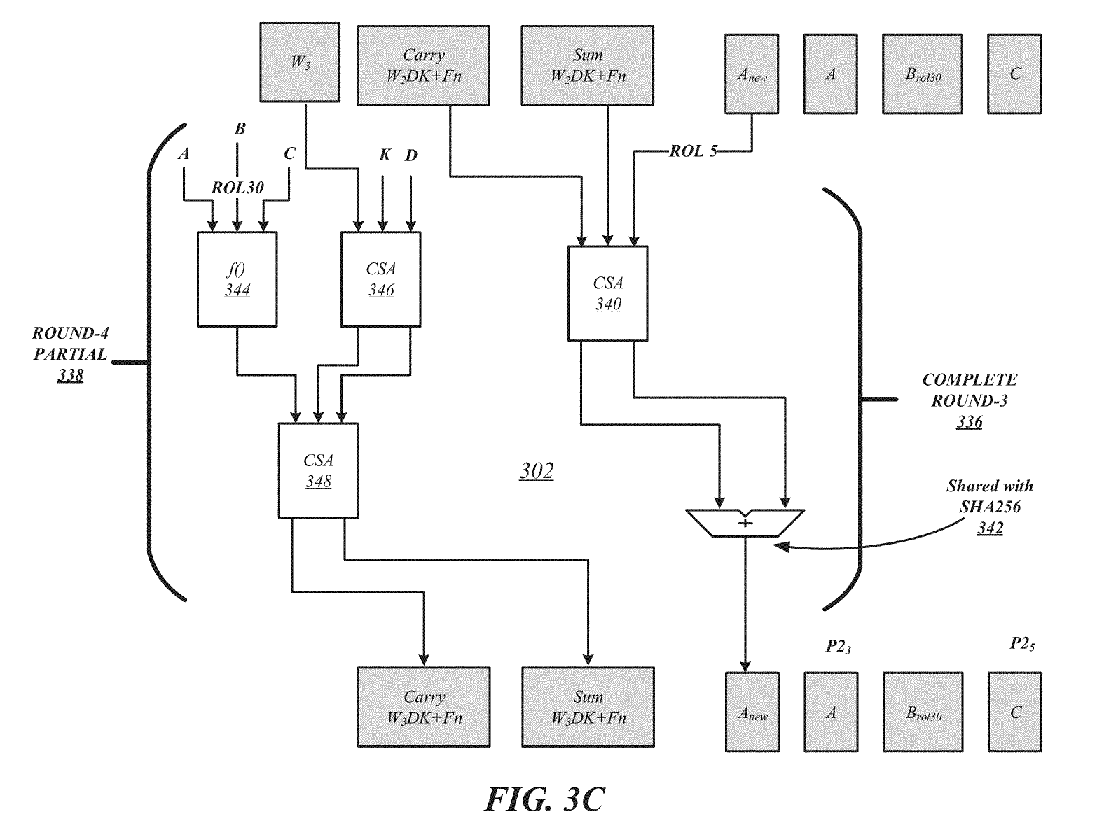

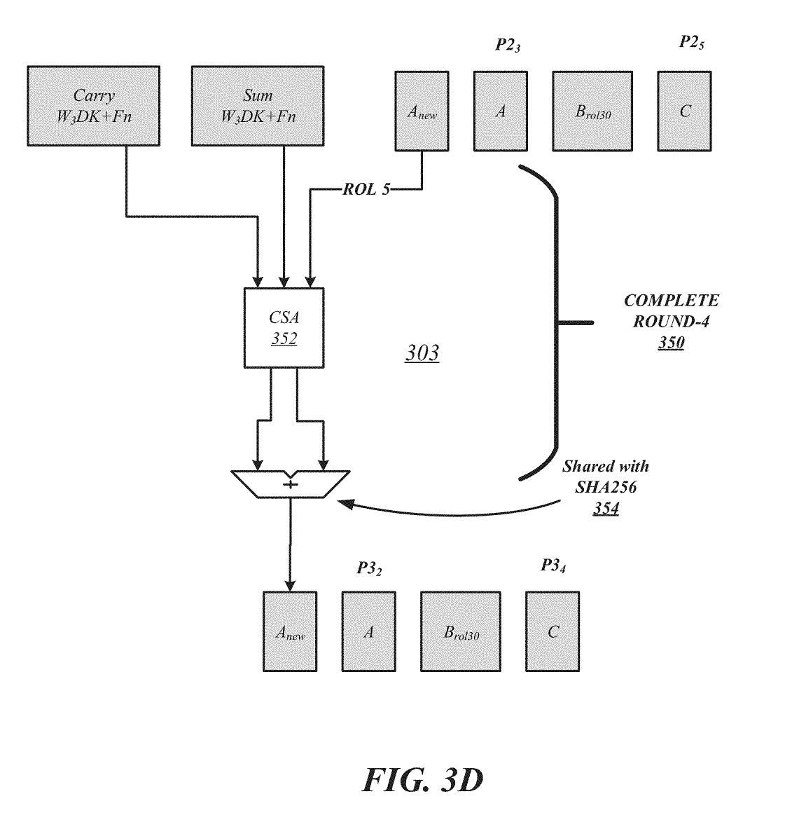

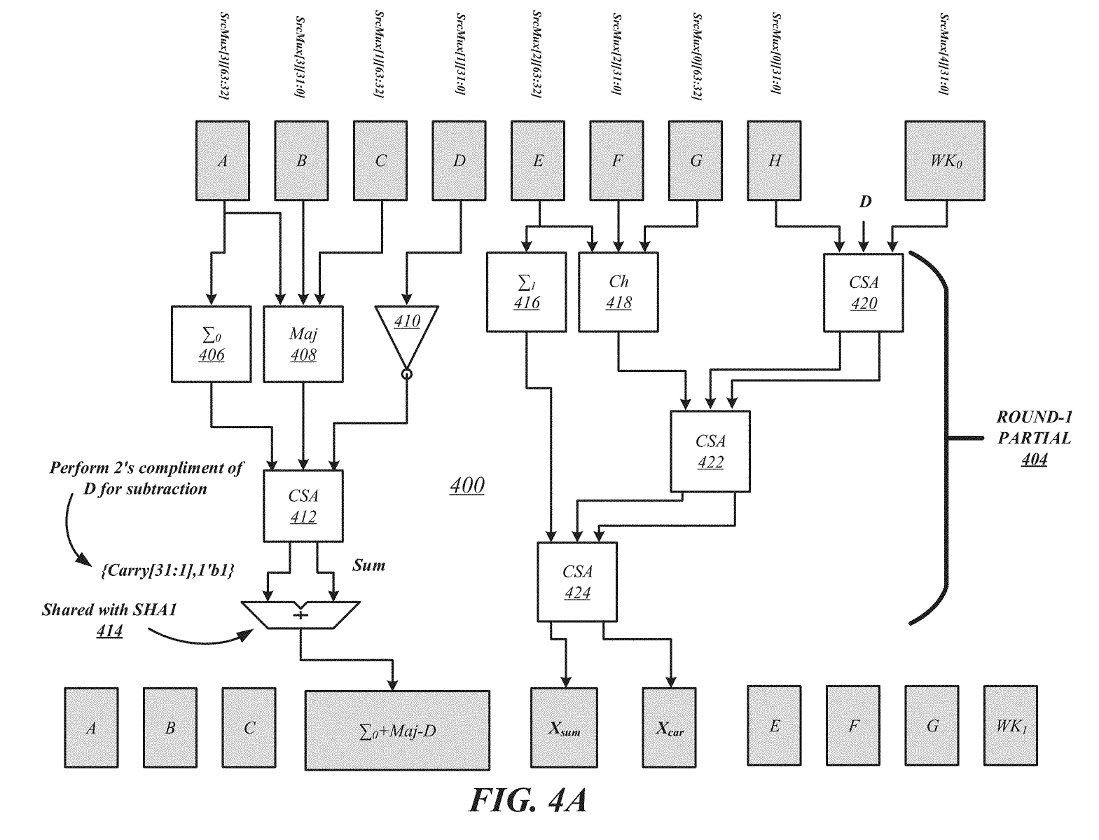

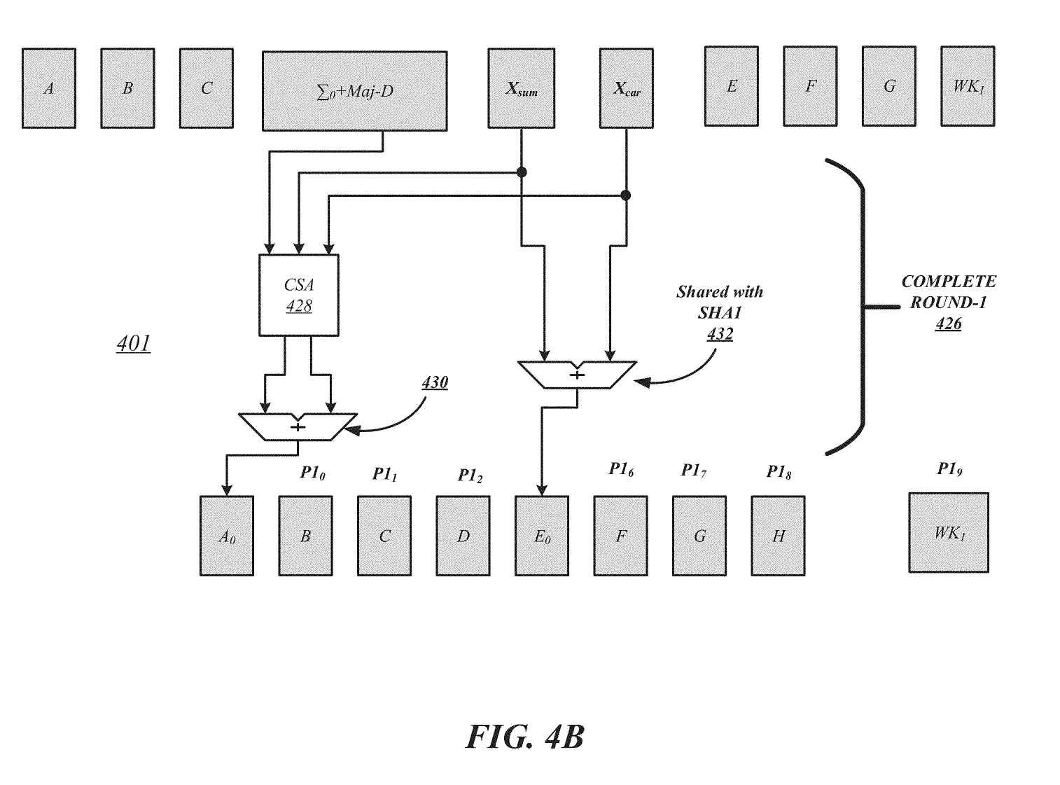

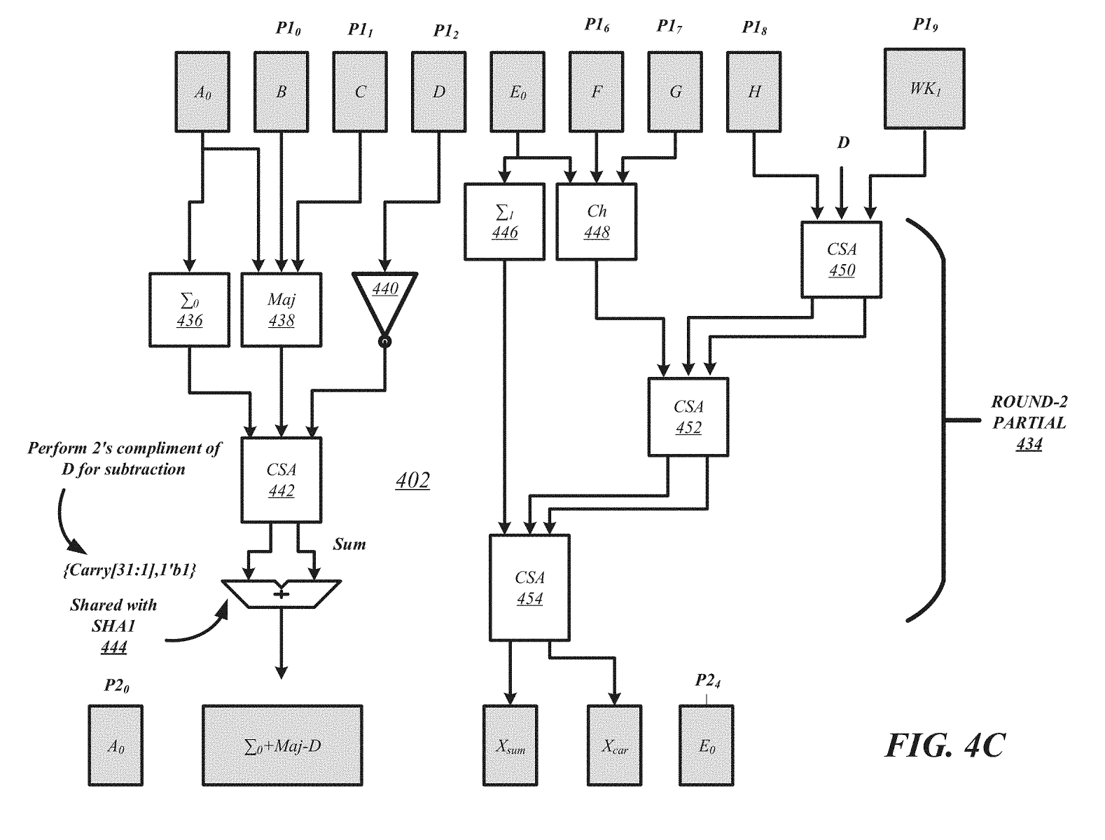

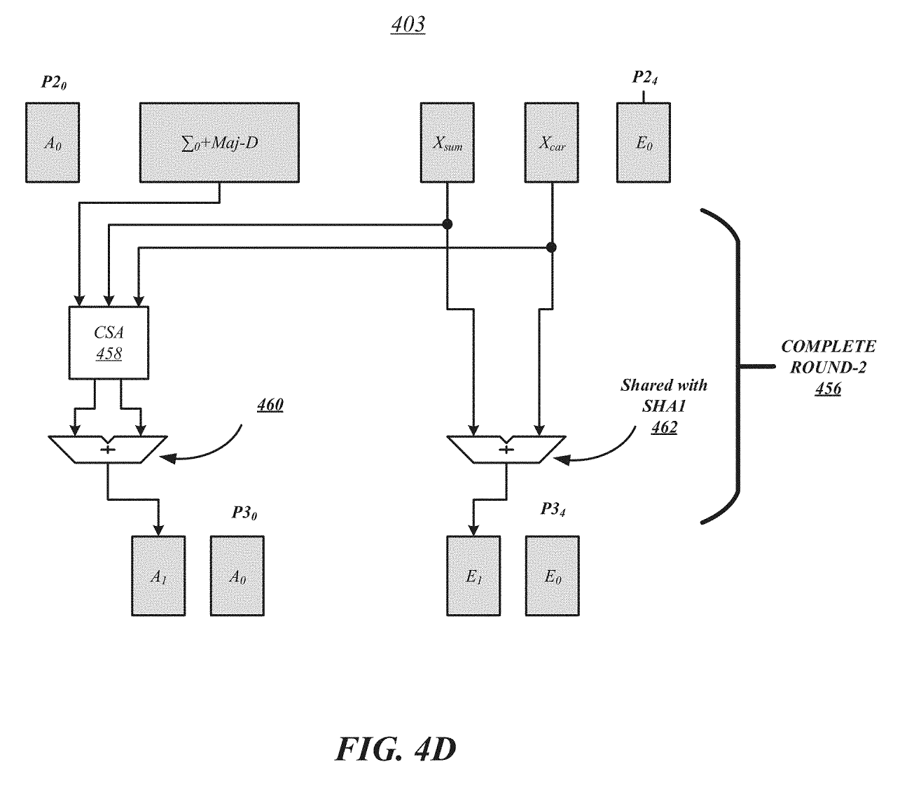

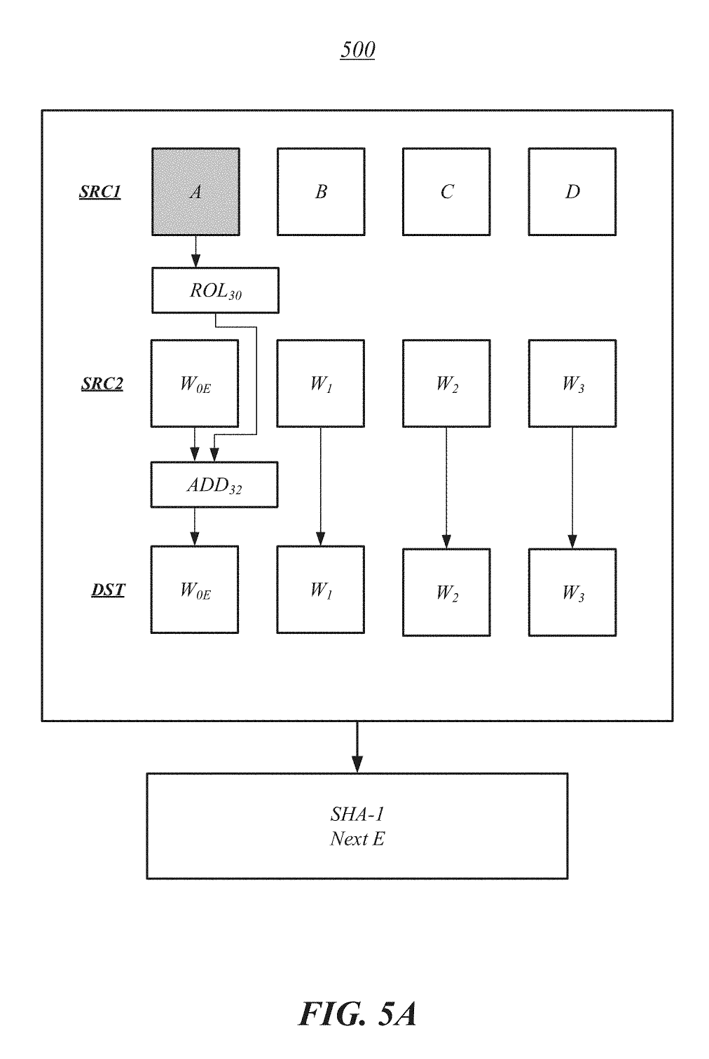

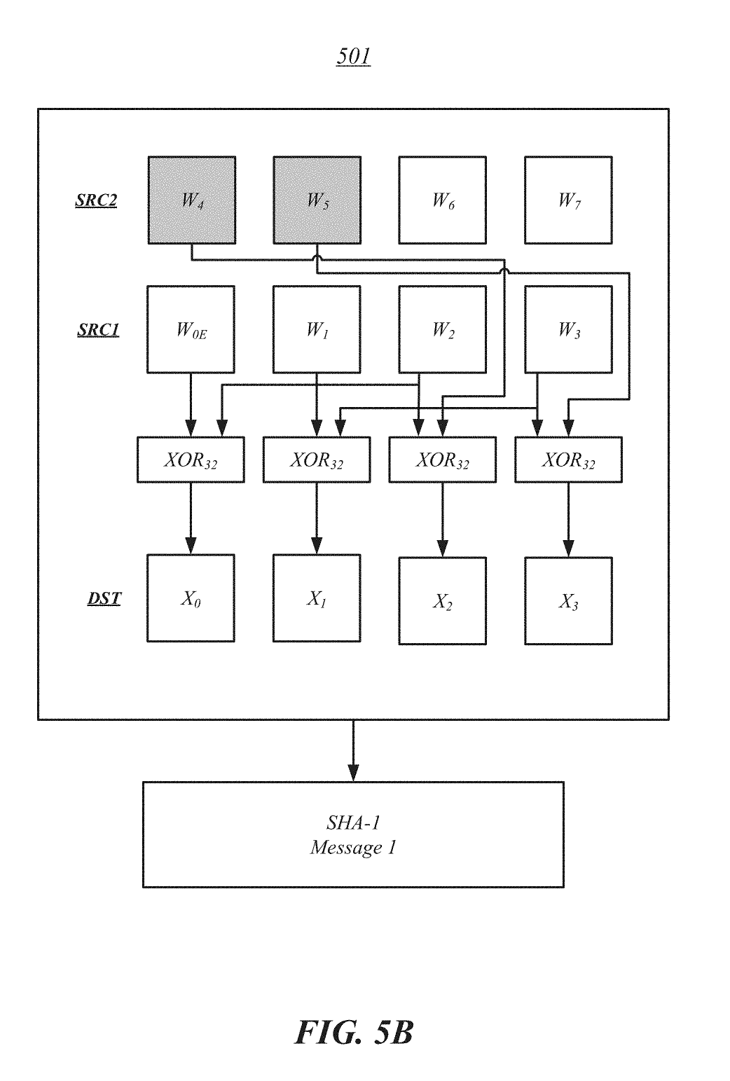

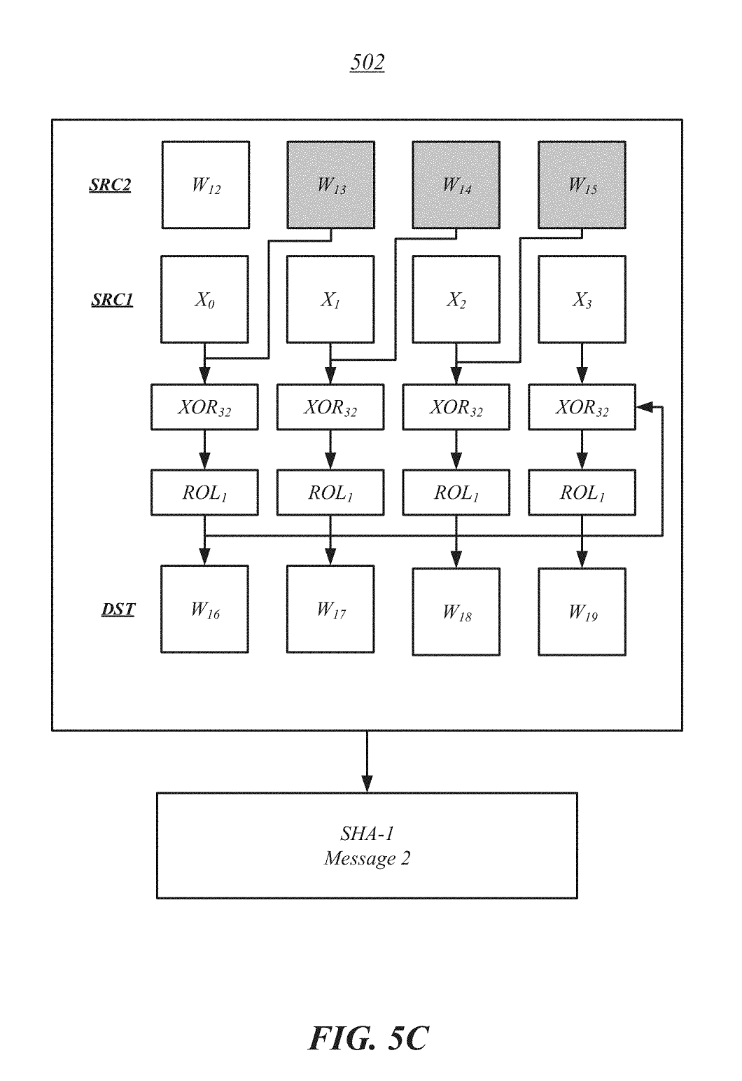

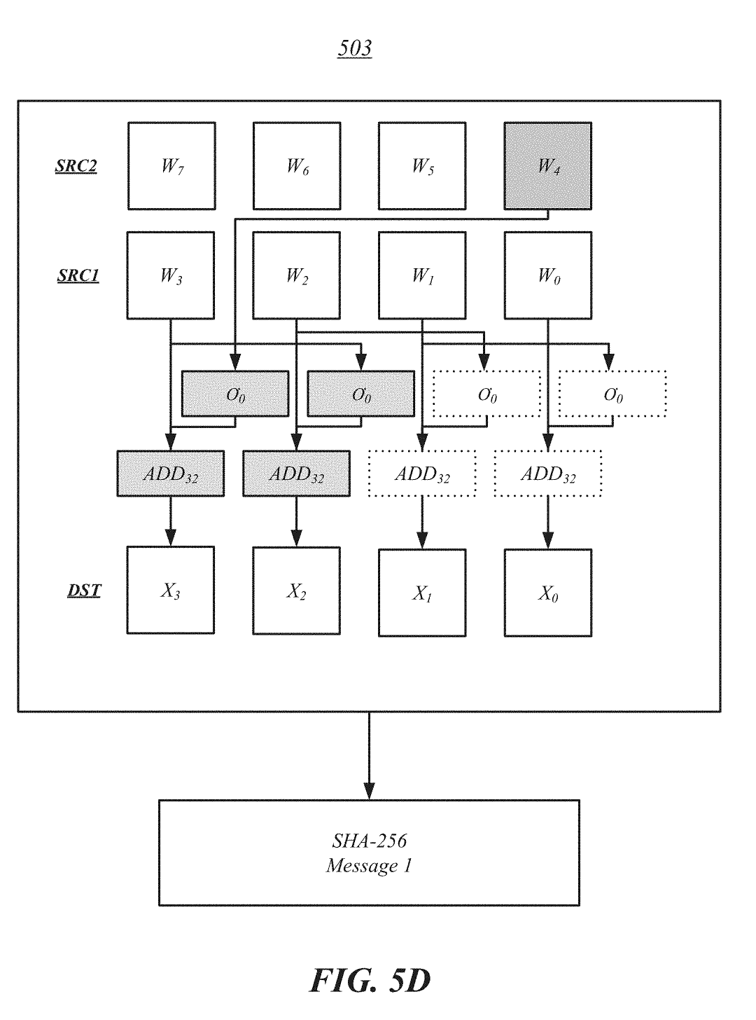

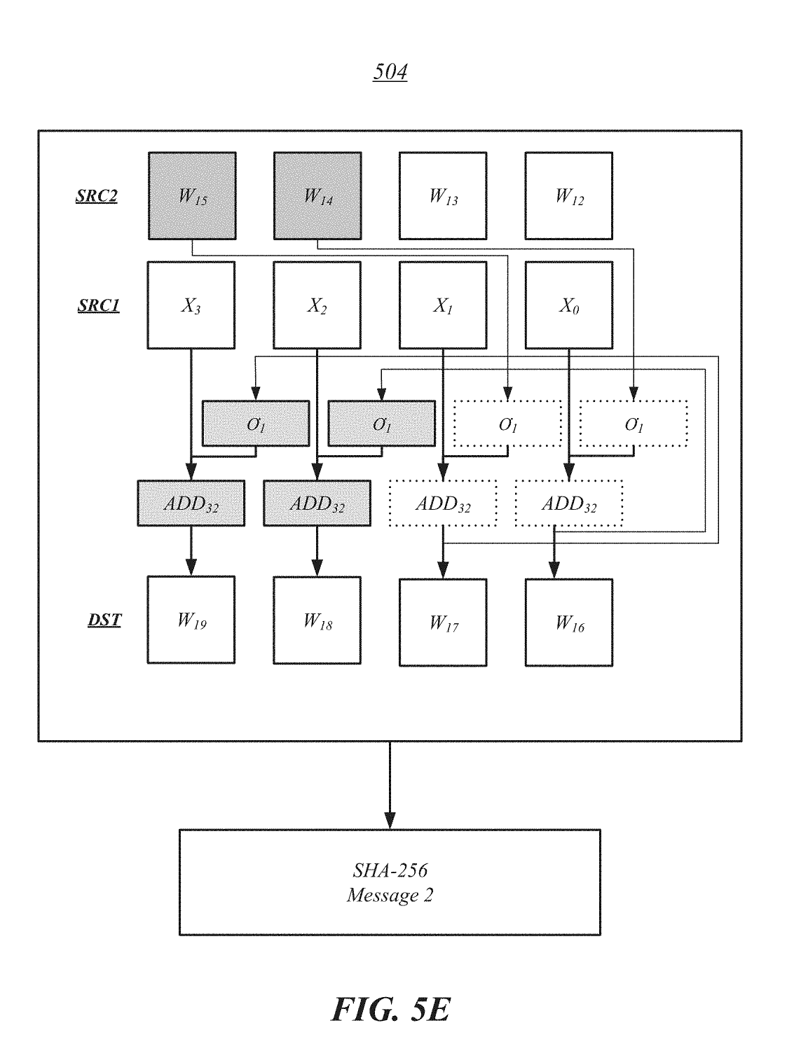

FIGS. 3A-3D illustrate embodiments of hash function circuitry split into four contiguous stages 300-303. As set forth within FIGS. 3A-3D, the end of each stage is replicated at the beginning of the next stage for purposes of illustration and clarity within each figure. The hash function circuitry illustrated within FIGS. 3A-3D represents a datapath for SHA-1 message digest round computation, split into four rounds or stages. As set forth below in FIGS. 4A-4D, the datapath for SHA-256 round computation, also split into four rounds or stages is also illustrated. It is important to note that the hash function circuitry of FIGS. 3A-3D and FIGS. 4A-4D (as well as FIGS. 5A-E) may be part of a single unified hardware accelerated hashing architecture. Certain elements have been highlighted within the figures for clarity.

FIG. 3A illustrates a first stage of hash function circuitry 300, including first computation round 304 and partial second computation round 306. An input message may be split into words W₀-W₃ along with constant K and values A-D, according to the SHA-1 specification. The computation of the first round 304 may be similar to conventional implementations of SHA-1 and may be performed in the first pipeline stage using f( ) 308, carry save adder (CSA) 310, CSA 312 and adder 314. However, the final completion adder 314 for the computation of A_{New} may be shared with the SHA-256 datapath (described later with respect to FIGS. 4A-4D) to reduce datapath area and power.

In some embodiments, a partial second round 306 may be configured to compute a portion of the computation traditionally performed in a second stage. For example, as illustrated, the computation of fn(B, C, D) by f( ) 316 may be performed using 32-bit states A, B, and C of the first round 304. Similarly, the addition of the next message word W₁, the second round constant K, and state D may be added using CSA 318. The output of f( ) 316 and CSA 318 may be added and stored in carry-save format using CSA 320, thereby partially completing the second round computation during the first round 304.

FIGS. 3B-3D illustrate subsequent pipeline stages 301, 302, and 303. In particular, FIG. 3B and FIG. 3C illustrate a shared adder and pre-computation architecture similar to that of FIG. 3A. In the second pipeline stage, 301, for example, the remaining computation of a second round 322 may be completed by adding A_{New} computed in the first round at CSA 326. In the third pipeline stage, 302, for example, the remaining computation of a third round 336 may be completed by adding A_{New} computed in the second round at CSA 340. As in the first round, the final completion adders 328 (FIG. 3B) and 342 (FIG. 3C) may be shared with a SHA-256 datapath. The fourth round, 350, depicted within FIG. 3D illustrates a shared adder 354 (accepting input from CSA 352), also shared with a SHA-256 datapath.

Like the first computation round of FIG. 3A, FIGS. 3B and 3C illustrates partial precomputation for subsequent rounds. In FIG. 3B, a precomputation partial round 324 may include f( ) 330, CSA 332, and 334. In FIG. 3C, a precomputation partial round 338 may include f( ) 344, CSA 346, and CSA 348. In each of these precomputation rounds, a portion of the next computation round may be performed and stored in carry-save format for access by the next round. The pre-computation of rounds two (306), three (324), and four (338) in the previous rounds may reduce the SHA-1 critical path in these stages from fifteen (15) to ten (10) gates, resulting in approximately a 33% increase in timing slack resulting in cell area and power reduction, in some exemplary embodiments.

FIGS. 4A-4D illustrate embodiments of hash function circuitry split into four contiguous stages 400-403. As set forth within FIGS. 4A-4D, the end of each stage is replicated at the beginning of the next stage for purposes of illustration and clarity within each figure. The hash function circuitry illustrated within FIGS. 4A-4D may represent a datapath for SHA-256 message digest round computation, split into four rounds or stages. As set forth above in FIGS. 3A-3D, the datapath for SHA-1 round computation, also split into four rounds or stages is also illustrated. It is important to note that the hash function circuitry of FIGS. 3A-3D and FIGS. 4A-4D (as well as FIGS. 5A-E) may be part of a single unified hardware accelerated hashing architecture. Certain elements have been highlighted within the figures for clarity.

As illustrated and described with respect to FIG. 2 above, the SHA-256 datapath of FIGS. 4A-4D may split two rounds of SHA-256 across four pipeline stages. FIG. 4A illustrates a first pipeline stage 400 including partial first round 404. Partial first round 404 may include the partial computation of E_{new} be performed by adding Σ₁ 416, Ch 418, H, D and WK₀ in carry-save format by CSAs 420, 422, and 424. The intermediate result in the carry-save format may be completed using the shared completion adder 432 in pipeline stage 401. Since A_{New}=Σ₀+Maj+Σ₁+Ch+H+WK₀ and E_{New}=Σ₁+Ch+H+D+WK₀, A_{New} may be reformulated as A_{New}=Σ₀+Maj+E_{New}−D. As a result, pipeline stage 400 may compute the factor Σ₀+Maj−D (406-408-410) in first pipeline stage 404 using the shared completion adder 414, which may be shared with SHA-1.

As illustrated in FIG. 4B, the addition of E_{New} in carry-save format may be performed and completed in a second pipeline stage 426 using adder 430. The pre-computation of E_{New} and subtraction of D may result in a 10-gate critical path in pipeline stages 401 and 403, resulting in approximately a 23% higher timing slack. Further, the 32-bit value of ‘D’ may not be require to be stored for the second pipeline stage 401 resulting in approximately 8.3% and 29% fewer sequential cells in the first pipeline stage 400 and third pipeline stage 402, respectively. The critical path in pipeline stages 400 and 402 may be equal to 13 logic gates using the disclosed architecture and may not require additional completion adders because of the adders (432, 444, 462) shared with SHA-1 datapath.

FIGS. 4C and 4D illustrate third and fourth pipelines stages similar to those described with respect to FIGS. 4A and 4B. In particular, FIG. 4C illustrates the third pipeline stage 402. Third pipelines stage 402 may include a second partial round 434 including the partial computation of E_{new}, which may be performed by adding Σ₁ 446, Ch 448, H, D and WK₁ in carry-save format by CSAs 450, 452, and 454. The intermediate result in the carry-save format may be completed using the shared completion adder 462 in pipeline stage 403. Since A_{New}=Σ₀+Maj+Σ₁+Ch+H+WK₁ and E_{New}=Σ₁+Ch+H+D+WK₁, A_{New} may be reformulated as A_{New}=Σ₀+Maj+E_{New}−D. As a result, pipeline stage 402 may compute the factor Σ₀+Maj−D (436-438-440) in third pipeline stage 402 using CSA 442 and the shared completion adder 444, which may be shared with SHA-1.

As illustrated in FIG. 4D, the addition of E_{New} in carry-save format may be performed and completed in a fourth pipeline stage 456 using adder 460. As set forth above, the pre-computation of E_{New} and subtraction of D may result in a 10-gate critical path in pipeline stages 401 and 403, resulting in approximately a 23% higher timing slack. Further, the 32-bit value of TY may not be require to be stored for the second pipeline stage 401 resulting in approximately 8.3% and 29% fewer sequential cells in the first pipeline stage 400 and third pipeline stage 402, respectively. The critical path in pipeline stages 400 and 402 may be equal to 13 logic gates using the disclosed architecture and may not require additional completion adders because of the adders (432, 444, 462) shared with SHA-1 datapath.

FIGS. 5A-5E illustrate embodiments of hash function logic circuitry split into five stages. In particular, FIGS. 5A-5E may illustrate state generation and message expansion logic that may be used in correlation with the hash function circuitry disclosed above with respect to FIGS. 3A-D and FIGS. 4A-4D. It is important to note that the hash function circuitry of FIGS. 5A-E, along with FIGS. 3A-3D and FIGS. 4A-4D, may be part of a single unified hardware accelerated hashing architecture, and may include common like-labeled elements. Certain elements have been highlighted within the figures for clarity. In some embodiments, SHA message expansion logic described herein with respect to FIGS. 5A-5E may include the hardware accelerator for message expansion in SHA-1 and SHA-256. The hardware accelerator may also support additional logic to compute the Next-E in SHA-1 due to similar latency and throughput requirements.

FIG. 5A illustrates logic 500, which may be configured to generate the next state E in SHA-1 hashing, which may be designated as W₀E within the other figures, such as in FIG. 3A, for example. FIGS. 5B-5E show the various logic for different message expansion operations, such as XOR₃₂ (logic 500), XOR₃₂/ROL₁ (logic 502), and ADD₃₂ (logic 503 and 504). The logic operations illustrated within FIGS. 5A-5E may be implemented using two pipeline stages in some embodiments. Further the logic operations illustrated within FIGS. 5A-5E may share intermediate registers and 32-bit adders used for Next-E (logic 500), SHA-256 Message 1 (logic 503) and SHA-256 Message 2 (logic 504) operations. The SHA-256 message expansion operation illustrated within FIGS. 5D and 5E may use two cycles of computation, while the other three operations (FIGS. 5A-C) may be completed in a first pipeline stage, and shifted into a second stage to match the latency/throughput of the ALU.

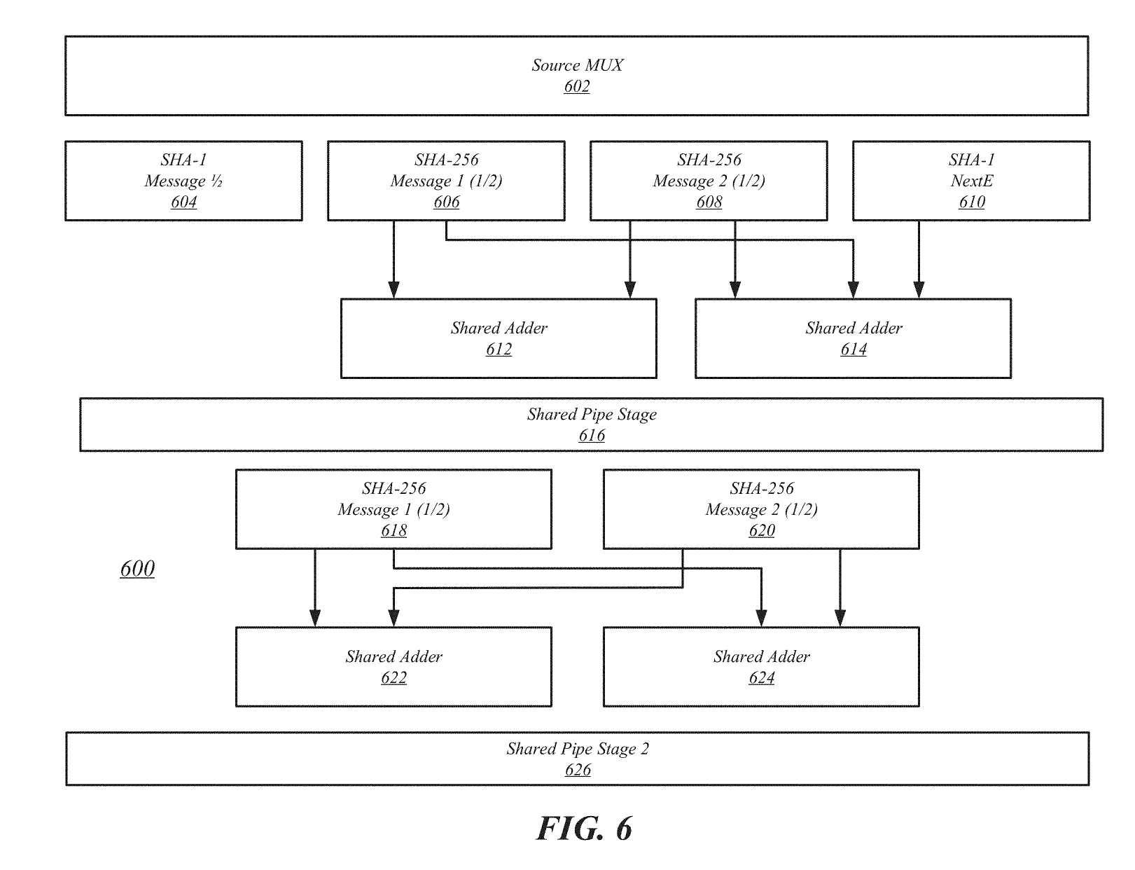

FIG. 6 illustrates an embodiment of message expansion hardware architecture. The message expansion logic 600 may have a latency of two cycles and a throughput of one cycle. As a result, the additions of the SHA256 logic may be spread across two clock cycles. The most area and power intensive operation in the SHA message expansion may be the 32-bit addition. The unified datapath using shared pipe stages 616 and 626 may allow the 32-bit adders 612, 614, 622, and 624 to be shared between all datapaths requiring the addition operation. As illustrated, two 32-bit adders 612 and 614 may be shared between SHA-256Msg1 606, SHA256-Msg2 608 and SHA1-NextE 610 in a first pipeline stage 616. The intermediate result of the addition of two σ₀ or σ₁ factors in SHA256Msg* 618 and 620 may then be added to two σ₀ or σ₁ factors in a second pipeline stage 626 using two additional shared 32-bit adders 618 and 620.

Some of the following figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. For example, a logic flow may be implemented by a processor component executing instructions stored on an article of manufacture, such as a storage medium. A storage medium may comprise any non-transitory computer-readable medium or machine-readable medium, such as an optical, magnetic or semiconductor storage. The storage medium may store various types of computer executable instructions, such as instructions to implement one or more disclosed logic flows. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

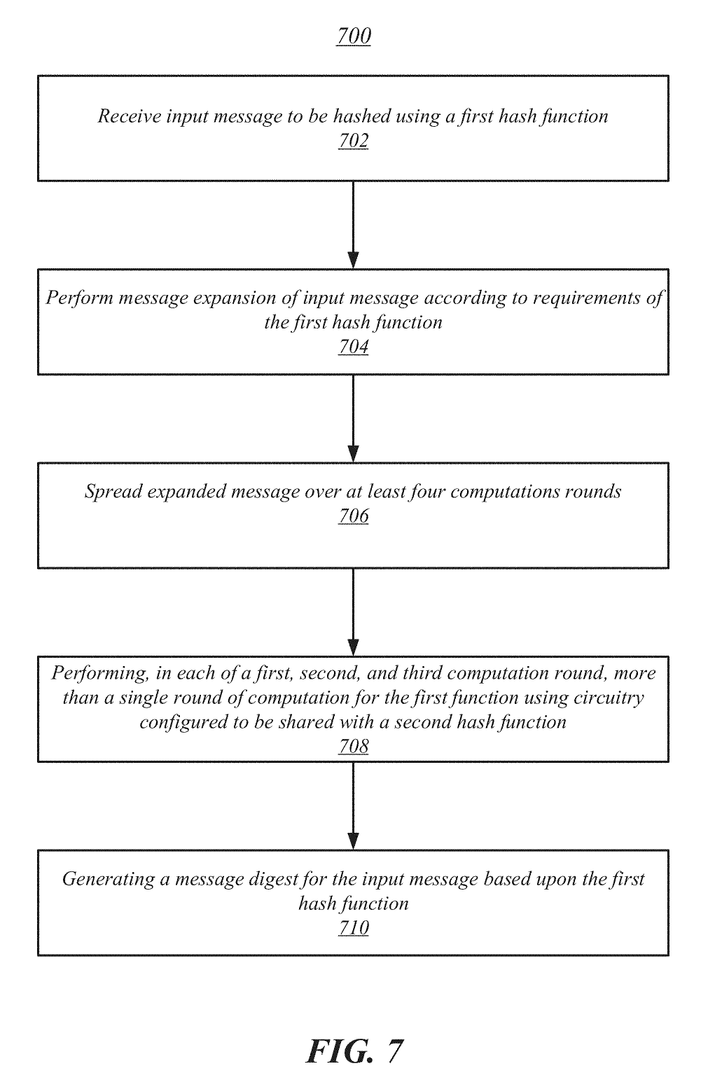

FIG. 7 depicts an exemplary logic flow 700 according to an embodiment. Logic flow 700 may be representative of some or all of the operations executed by one or more embodiments described herein. For example, logic flow 700 may illustrate operations performed by the various processor components described herein.

In the illustrated embodiment shown in FIG. 7, at 702, logic flow 700 may receive an input message from a multiplexed source for hashing using one of a plurality of hash functions, such as SHA-1 or SHA-256. The input message may be electronic data that is to be hashed using a hash function. Since an input message may not be of the appropriate length to create evenly-sized words for a hash algorithm, there may be a need to expand the message according to the requirements of a hash function, which may be performed at 704.

At 706, an expanded input message may be spread over at least four computation rounds. As set forth in detail above, a SHA-1 and SHA-256 unified hardware acceleration architecture may perform SHA-1 in four computations rounds and split two computation rounds of SHA-256 into four stages, as illustrated within FIGS. 3A-3D and FIGS. 4A-4D.

At 708, each of a first, second, and third computation round may be performed such that more than a single computation round is achieved. For example, as described above, in a SHA-1 datapath, round 1 may be performed and a portion of round 2 may be precomputed. In this manner, for each of the first three rounds, some precomputation for the next round may be achieved, ultimately creating a more efficient architecture. During each computation round, at least one set of adding circuitry may be used that is shared with a second hash algorithm. For example, during a SHA-1 datapath, one or more adders may be shared with the datapath of a SHA-256 algorithm, as illustrated and described herein. Finally, after one or more iterations, at 710, the system may generate a message digest for the input message based upon the first hash function.

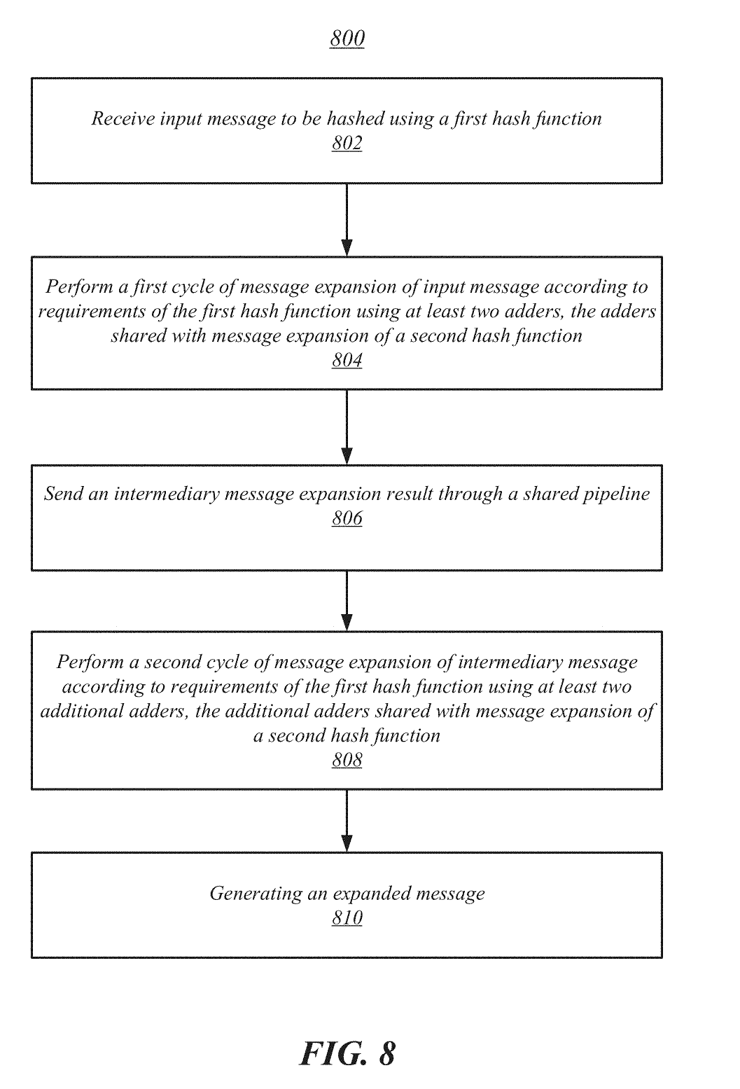

FIG. 8 depicts an illustrative logic flow according to a second embodiment. More specifically, FIG. 8 illustrates one embodiment of a logic flow 800 that may set forth one or more functions performed by the unified message expansion architecture of FIG. 6. Logic flow 800 may be representative of some or all of the operations executed by one or more embodiments described herein. For example, logic flow 800 may illustrate operations performed by the processing devices described herein.

At 802, logic flow 800 may receive an input message from a multiplexed source for hashing using one of a plurality of hashing functions, such as SHA-1 or SHA-256. The input message may be electronic data that is to be hashed using a hash function. Since an input message may not be of the appropriate length to create evenly-sized words for a hash algorithm, there may be a need to expand the message according to the requirements of a hash function, which may be performed by the following portions of logic flow 800.

At 804, logic flow 800 may perform a first cycle of message expansion of the input message according to requirements of the first hash function using at least two sets of adding circuitry. The adders may be shared with message expansion of a second hash function. In an example, a SHA-1 and SHA-256 unified hardware acceleration architecture may perform message expansion using shared 32-bit adders.

At 806, an intermediary message expansion result may be sent through a pipeline shared between the first and second hash functions. In an example, a SHA-1 and SHA-256 message expansion may share one or more pipelines, as set forth within the illustrated and described architectures herein.

At 808, a second cycle of message expansion of the intermediary message may be performed according to the requirements of the first hash function using at least two additional adders, the additional adders shared with the message expansion circuitry of a second hash function. After the second round of message expansion at 808, an expanded message compliant with the standard of the first hash function may be generated. In some embodiments, message expansion may be performed in parallel, and using the same circuitry components, as the hash function itself. Thus, as computation rounds are performed according to a hash function, an input message may be expanded.

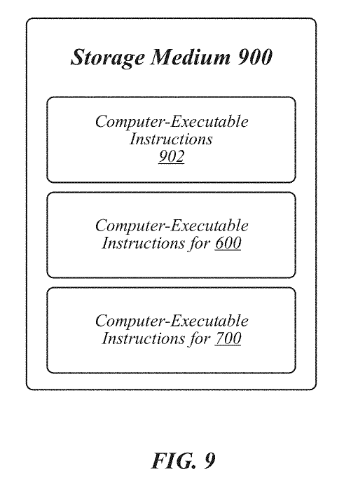

FIG. 9 illustrates an example of a storage medium 900. Storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions 902, which may correspond to any embodiment described herein, or to implement logic flow 700 and/or logic flow 800. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

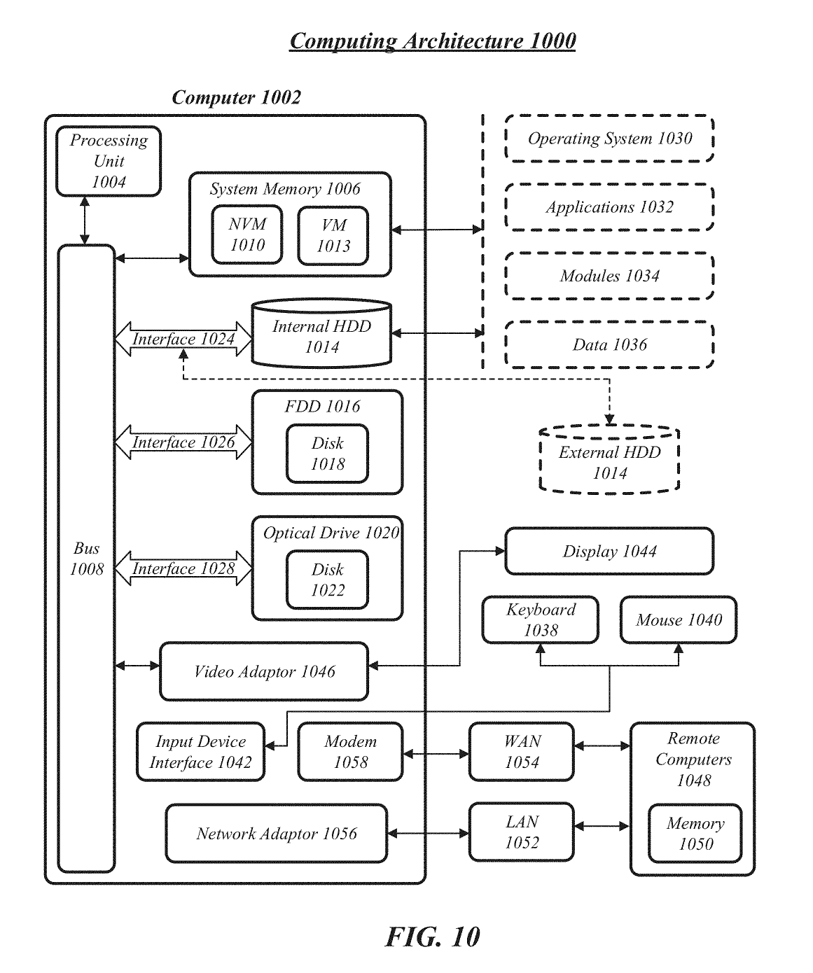

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004. For example, the unified hardware acceleration for hash functions described herein may be performed by processing unit 1004 in some embodiments.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1013. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM, DVD, or Blu-ray). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1013, including an operating system 1030, one or more application programs 1032, other program modules 1034, and program data 1036. In one embodiment, the one or more application programs 1032, other program modules 1034, and program data 1036 can include, for example, the various applications and/or components to implement the disclosed embodiments.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A display 1044 is also connected to the system bus 1008 via an interface, such as a video adaptor 1046. The display 1044 may be internal or external to the computer 1002. In addition to the display 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Examples may include subject matter such as a method, means for performing acts of the method, at least one machine-readable medium including instructions that, when performed by a machine cause the machine to performs acts of the method, or of an apparatus or system for hardware accelerated hash operations according to embodiments and examples described herein.

Example 1 is an apparatus for hardware accelerated hashing in a computer system, comprising: at least one memory; at least one processor; and logic including at least one adding circuit shared between a first hash function and a second hash function, the logic to perform hardware accelerated hashing of an input message stored in the at least one memory, at least a portion of the logic comprised in hardware and executed by the processor, the logic to: receive the input message to be hashed using the first hash function; perform message expansion of the input message per requirements of the first hash function; perform hashing of the expanded input message over at least four computation rounds; perform, in each of a first, second, and third computation round, more than a single round of computation for the first hash function; and generate a message digest for the input message based upon the first hash function.

Example 2 is the apparatus of Example 1, the logic comprising message expansion logic to: receive the input message; perform a first cycle of message expansion of the input message using at least two adding circuits shared with message expansion logic of the second hash function to generate an intermediary message expansion; send the intermediary message expansion through a shared message expansion pipeline; and perform a second cycle of message expansion of the intermediary message using at least two additional adding circuits shared with message expansion logic of the second hash function to generate an expanded message.

Example 3 is the apparatus of Example 1, further comprising a pipeline stage after each computation round shared between the first hash function and the second hash function

Example 4 is the apparatus of Example 1, wherein the first hash function is SHA-1.

Example 5 is the apparatus of Example 1, wherein the second hash function is SHA-256.

Example 6 is the apparatus of Example 1, the logic comprising at least one shared adding circuit between each of the four computation rounds.

Example 7 is the apparatus of Example 1, the logic to precompute a portion of the following computation round in each of computation rounds one, two, and three.

Example 8 is the apparatus of Example 1, the logic configured to split computation between four computation rounds of the second hash algorithm, with intermediate results of each of the first three rounds being saved in carry-save format.

Example 9 is the apparatus of Example 3, the at least one shared adding circuit and the shared pipeline stage reducing a cell area.

Example 10 is a computer-implemented method for hardware accelerated hashing in a computer system, comprising: receiving, by logic including at least one adding circuit shared between a first hash function and a second hash function, an input message to be hashed using the first hash function; performing message expansion of the input message per requirements of the first hash function; performing hashing of the expanded input message over at least four computation rounds; performing, in each of a first, second, and third computation round, more than a single round of computation for the first hash function; and generating a message digest for the input message based upon the first hash function.

Example 11 is the computer-implemented method of Example 10, the logic comprising message expansion logic to: receive the input message; perform a first cycle of message expansion of the input message using at least two adding circuits shared with message expansion logic of the second hash function to generate an intermediary message expansion; and send the intermediary message expansion through a shared message expansion pipeline; and perform a second cycle of message expansion of the intermediary message using at least two additional adding circuits shared with message expansion logic of the second hash function to generate an expanded message.

Example 12 is the computer-implemented method of Example 12, further comprising sharing a pipeline stage after each computation round between the first hash function and the second hash function.

Example 13 is the computer-implemented method of Example 10, wherein the first hash function is SHA-1.

Example 14 is the computer-implemented method of Example 10, wherein the second hash function is SHA-256.

Example 15 is the computer-implemented method of Example 10, further comprising sharing at least one adding circuit between each of the four computation rounds.

Example 16 is the computer-implemented method of Example 10, further comprising precomputing a portion of the following computation round in each of computation rounds one, two, and three.

Example 17 is the computer-implemented method of Example 10, further comprising splitting computation between four computation rounds of the second hash algorithm, with intermediate results of each of the first three rounds being saved in carry-save format.

Example 18 is a computer-readable storage medium that stores instructions for execution by processing circuitry of a computing device for hardware accelerated hashing, the instructions to cause the computing device to receive an input message to be hashed using the first hash function; perform message expansion of the input message per requirements of the first hash function; perform hashing of the expanded input message over at least four computation rounds; perform, in each of a first, second, and third computation round, more than a single round of computation for the first hash function; and generate a message digest for the input message based upon the first hash function.

Example 19 is the computer-readable storage medium of Example 18, the logic comprising message expansion logic to receive the input message; perform a first cycle of message expansion of the input message using at least two adding circuits shared with message expansion logic of the second hash function to generate an intermediary message expansion; and send the intermediary message expansion through a shared message expansion pipeline; and perform a second cycle of message expansion of the intermediary message using at least two additional adding circuits shared with message expansion logic of the second hash function to generate an expanded message.

Example 20 is the computer-readable storage medium of Example 18, further comprising sharing a pipeline stage after each computation round between the first hash function and the second hash function.

Example 21 is the computer-readable storage medium of Example 18, wherein the first hash function is SHA-1.

Example 22 is the computer-readable storage medium of Example 18, wherein the second hash function is SHA-256.

Example 23 is the computer-readable storage medium of Example 18, further comprising sharing at least one adding circuit between each of the four computation rounds.

Example 24 is the computer-readable storage medium of Example 18, further comprising precomputing a portion of the following computation round in each of computation rounds one, two, and three.

Example 25 is the computer-readable storage medium of Example 18, further comprising splitting computation between four computation rounds of the second hash algorithm, with intermediate results of each of the first three rounds being saved in carry-save format.

Example 26 is a system for hardware accelerated hashing in a computer system, comprising: at least one memory; at least one processor; an accelerated hashing module comprising logic including at least one adding circuit shared between a first hash function and a second hash function, the logic to perform hardware accelerated hashing of an input message stored in the at least one memory, at least a portion of the logic comprised in hardware and executed by the processor, the logic to: receive the input message to be hashed using the first hash function; perform message expansion of the input message per requirements of the first hash function; perform hashing of the expanded input message over at least four computation rounds; perform, in each of a first, second, and third computation round, more than a single round of computation for the first hash function; and generate a message digest for the input message based upon the first hash function.

Example 27 is the system of Example 26, comprising a message expansion module comprising logic to: receive the input message; perform a first cycle of message expansion of the input message using at least two adding circuits shared with message expansion logic of the second hash function to generate an intermediary message expansion; send the intermediary message expansion through a shared message expansion pipeline; and perform a second cycle of message expansion of the intermediary message using at least two additional adding circuits shared with message expansion logic of the second hash function to generate an expanded message.

Example 28 is the system of Example 26, further comprising a pipeline stage after each computation round shared between the first hash function and the second hash function.

Example 29 is the system of Example 26, wherein the first hash function is SHA-1.

Example 30 is the system of Example 26, wherein the second hash function is SHA-256.

Example 31 is the system of Example 26, the logic comprising at least one shared adding circuit between each of the four computation rounds.

Example 32 is the system of Example 26, the logic to precompute a portion of the following computation round in each of computation rounds one, two, and three.

Example 33 is the system of Example 26, the logic configured to split computation between four computation rounds of the second hash algorithm, with intermediate results of each of the first three rounds being saved in carry-save format.

Example 34 is the system of Example 26, the at least one shared adding circuit and the shared pipeline stage reducing a cell area.

Example 35 is an apparatus for hardware accelerated hashing in a computer system, comprising: means for receiving, by logic including at least one adding circuit shared between a first hash function and a second hash function, an input message to be hashed using the first hash function; means for performing message expansion of the input message per requirements of the first hash function; means for performing hashing of the expanded input message over at least four computation rounds; means for performing, in each of a first, second, and third computation round, more than a single round of computation for the first hash function; and means for generating a message digest for the input message based upon the first hash function.

Example 36 is the apparatus of Example 35, the logic comprising message expansion logic comprising: means for receiving the input message; means for performing a first cycle of message expansion of the input message using at least two adding circuits shared with message expansion logic of the second hash function to generate an intermediary message expansion; and means for sending the intermediary message expansion through a shared message expansion pipeline; and means for performing a second cycle of message expansion of the intermediary message using at least two additional adding circuits shared with message expansion logic of the second hash function to generate an expanded message.

Example 37 is the apparatus of Example 35, further comprising means for sharing a pipeline stage after each computation round between the first hash function and the second hash function

Example 38 is the apparatus of Example 35, wherein the first hash function is SHA-1.

Example 39 is the apparatus of Example 35, wherein the second hash function is SHA-256.

Example 40 is the apparatus of Example 35, further comprising means for sharing at least one adding circuit between each of the four computation rounds.

Example 41 is the apparatus of Example 35, further comprising means for precomputing a portion of the following computation round in each of computation rounds one, two, and three.

Example 42 is the apparatus of Example 35, further comprising means for splitting computation between four computation rounds of the second hash algorithm, with intermediate results of each of the first three rounds being saved in carry-save format.

What is claimed is:

1. An apparatus for hardware accelerated hashing in a computer system, comprising:
at least one memory;
at least one processor; and
logic including at least one adding circuit shared between a first hash function and a second hash function, the logic to perform hardware accelerated hashing of an input message stored in the at least one memory, at least a portion of the logic comprised in hardware and executed by the processor, the logic to:
receive the input message to be hashed using the first hash function;
perform message expansion of the input message per requirements of the first hash function;
perform hashing of the expanded input message over at least four computation rounds;
perform, in each of a first, second, and third computation round, more than a single round of computation for the first hash function; and
generate a message digest for the input message based upon the first hash function.

2. The apparatus of claim 1, the logic comprising message expansion logic to:
receive the input message;
perform a first cycle of message expansion of the input message using at least two adding circuits shared with message expansion logic of the second hash function to generate an intermediary message expansion;
send the intermediary message expansion through a shared message expansion pipeline; and
perform a second cycle of message expansion of the intermediary message using at least two additional adding circuits shared with message expansion logic of the second hash function to generate an expanded message.

3. The apparatus of claim 1, further comprising a pipeline stage after each computation round shared between the first hash function and the second hash function.

4. The apparatus of claim 1, wherein the first hash function is SHA-1.

5. The apparatus of claim 1, wherein the second hash function is SHA-256.

6. The apparatus of claim 1, the logic comprising at least one shared adding circuit between each of the four computation rounds.

7. The apparatus of claim 1, the logic to precompute a portion of the following computation round in each of computation rounds one, two, and three.

8. The apparatus of claim 1, the logic configured to split computation between four computation rounds of the second hash algorithm, with intermediate results of each of the first three rounds being saved in carry-save format.

9. The apparatus of claim 3, the at least one shared adding circuit and the shared pipeline stage reducing a cell area.

10. A computer-implemented method for hardware accelerated hashing in a computer system, comprising:
receiving, by logic including at least one adding circuit shared between a first hash function and a second hash function, an input message to be hashed using the first hash function;
performing message expansion of the input message per requirements of the first hash function;
performing hashing of the expanded input message over at least four computation rounds;
performing, in each of a first, second, and third computation round, more than a single round of computation for the first hash function; and
generating a message digest for the input message based upon the first hash function.

11. The computer-implemented method of claim 10, the logic comprising message expansion logic to:
receive the input message;
perform a first cycle of message expansion of the input message using at least two adding circuits shared with message expansion logic of the second hash function to generate an intermediary message expansion;
send the intermediary message expansion through a shared message expansion pipeline; and
perform a second cycle of message expansion of the intermediary message using at least two additional adding circuits shared with message expansion logic of the second hash function to generate an expanded message.

12. The computer-implemented method of claim 10, further comprising sharing a pipeline stage after each computation round between the first hash function and the second hash function.

13. The computer-implemented method of claim 10, wherein the first hash function is SHA-1.

14. The computer-implemented method of claim 10, wherein the second hash function is SHA-256.

15. The computer-implemented method of claim 10, further comprising sharing at least one adding circuit between each of the four computation rounds.

16. The computer-implemented method of claim 10, further comprising precomputing a portion of the following computation round in each of computation rounds one, two, and three.

17. The computer-implemented method of claim 10, further comprising splitting computation between four computation rounds of the second hash algorithm, with intermediate results of each of the first three rounds being saved in carry-save format.

18. A computer-readable storage medium that stores instructions for execution by processing circuitry of a computing device for hardware accelerated hashing, the instructions to cause the computing device to:
receive an input message to be hashed using the first hash function;
perform message expansion of the input message per requirements of the first hash function;
perform hashing of the expanded input message over at least four computation rounds;
perform, in each of a first, second, and third computation round, more than a single round of computation for the first hash function; and
generate a message digest for the input message based upon the first hash function.

19. The computer-readable storage medium of claim 18, the logic comprising message expansion logic to:
receive the input message;
perform a first cycle of message expansion of the input message using at least two adding circuits shared with message expansion logic of the second hash function to generate an intermediary message expansion;
send the intermediary message expansion through a shared message expansion pipeline; and
perform a second cycle of message expansion of the intermediary message using at least two additional adding circuits shared with message expansion logic of the second hash function to generate an expanded message.

20. The computer-readable storage medium of claim 18, further comprising sharing a pipeline stage after each computation round between the first hash function and the second hash function.

21. The computer-readable storage medium of claim 18, wherein the first hash function is SHA-1.

22. The computer-readable storage medium of claim 18, wherein the second hash function is SHA-256.

23. The computer-readable storage medium of claim 18, further comprising sharing at least one adding circuit between each of the four computation rounds.

24. The computer-readable storage medium of claim 18, further comprising precomputing a portion of the following computation round in each of computation rounds one, two, and three.

25. The computer-readable storage medium of claim 18, further comprising splitting computation between four computation rounds of the second hash algorithm, with intermediate results of each of the first three rounds being saved in carry-save format.
